(19) United States
(12) Patent Application Publication
(10) Pub. No.: US 2006/0013447 A1
(43) Pub. Date: Jan. 19, 2006

(54) Hand-held personal identification analysis device and methods of use

(75) Inventors: William G. Siegel, Wellington, FL (US); Ronnie Leighty, Lutz, FL (US); Christian Liautaud, Boca Raton, FL (US); Aleksandr A. Sorokin, Palm City, FL (US); Timothy S. McDow, Jupiter, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc., Palm Beach Gardens, FL (US)

(21) Appl. No.: 11/097,124

(22) Filed: Apr. 4, 2005

Related U.S. Application Data
(60) Provisional application No. 60/588,388, filed on Jul. 16, 2004.

(51) Int. Cl. G06K 9/00

(52) U.S. Cl. 382/115

(57) ABSTRACT

A hand-held personal identification analysis device is provided. The hand-held personal identification analysis device includes a scanning system for gathering biometric information from individuals, a profiler system for developing profiles of individuals based on biometric information gathered from the scanning system, and a personal data assistant or similar computing device with a screen for providing a user interface and overall system control A scanning system interface couples the scanning system to said computer module.

### CROSS REFERENCE TO RELATED APPLICATIONS

This application claims the benefit of priority to U.S. Provisional Patent Application No. 60/588,388, filed on Jul. 16, 2004, which is herein incorporated in its entirety by reference.

### BACKGROUND OF THE INVENTION

1. Field of the Invention

The present invention relates to biometrics, and more particularly, to a hand-held personal identification analysis device.

2. Background of Invention

Biometrics is the science of biological characteristic analysis. A biometric is a measurable, physical characteristic or personal behavioral trait used to recognize or verify the identity of a person. Historically, biometric information was gathered using equipment at a fixed location, such as a police station or an immigration office. Increasingly, law enforcement officers, other security officials and even college administrators seek to gather biometric information for individuals at a wide variety of locations. For example, law enforcement officers seek to collect fingerprints and mug shots for suspects in a wide range of remote locations. Additionally, security personnel at airports can use biometric information gathered from employees circulating throughout an airport to verify employee identification and track employee whereabouts. Existing devices to gather biometric information are often not suited for remote, in-field use. Even when they are useable for remote use, they are cumbersome or lack the ability to efficiently process and compile information in real time.

What is needed is a hand-held personal identification analysis device that supports efficient biometric information capture and processing.

### SUMMARY OF THE INVENTION

The present invention is directed to a hand-held personal identification analysis device. The hand-held personal identification analysis device includes a scanning system for gathering biometric information from individuals, a profiler system for developing profiles of individuals based on biometric information gathered from the scanning system, and a personal data assistant or similar computing device with a screen for providing a user interface and overall system control A scanning system interface couples the scanning system to the computing device.

In embodiments, the profiler system includes a profile developer that creates an individual profile by combining a biometric image with supplementary data. As used herein, profile is used broadly to represent any combination or compilation of biometric information with supplementary data related to the individual for which the biometric information pertains and to the environment or situation in which the profile was created.

There are numerous benefits associated with the use of a hand-held personal identification analysis device. These include, but are not limited to, providing an efficient way to capture and process biometric information at remote locations, while supporting in-field use.

Further embodiments, features, and advantages of the invention, as well as the structure and operation of the various embodiments of the invention are described in detail below with reference to accompanying drawings.

### BRIEF DESCRIPTION OF THE FIGURES

The invention is described with reference to the accompanying drawings. In the drawings, like reference numbers indicate identical or functionally similar elements. The drawing in which an element first appears is indicated by the left-most digit in the corresponding reference number.

FIG. 1 is a block diagram of a hand-held personal identification analysis device, according to an embodiment of the invention.

FIG. 2 is a block diagram of a scanning system used within a hand-held personal identification analysis device, according to an embodiment of the invention.

FIG. 3 is a block diagram of a profiler system used within a hand-held personal identification analysis device, according to an embodiment of the invention.

FIG. 4 is a diagram of a hand-held personal identification analysis device, according to an embodiment of the invention.

FIG. 5 is a diagram of a collection of perspective views of a hand-held personal identification analysis device, according to an embodiment of the invention.

FIG. 6 is a diagram of a bottom portion of an enclosure for a hand-held personal identification analysis device, according to an embodiment of the invention.

FIG. 7 is a diagram of a bottom and top portion of an enclosure for a hand-held personal identification analysis device, according to an embodiment of the invention.

FIG. 8 is a flowchart of a method for analyzing personal identity information of an individual using a hand-held personal identification analysis device, according to an embodiment of the invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

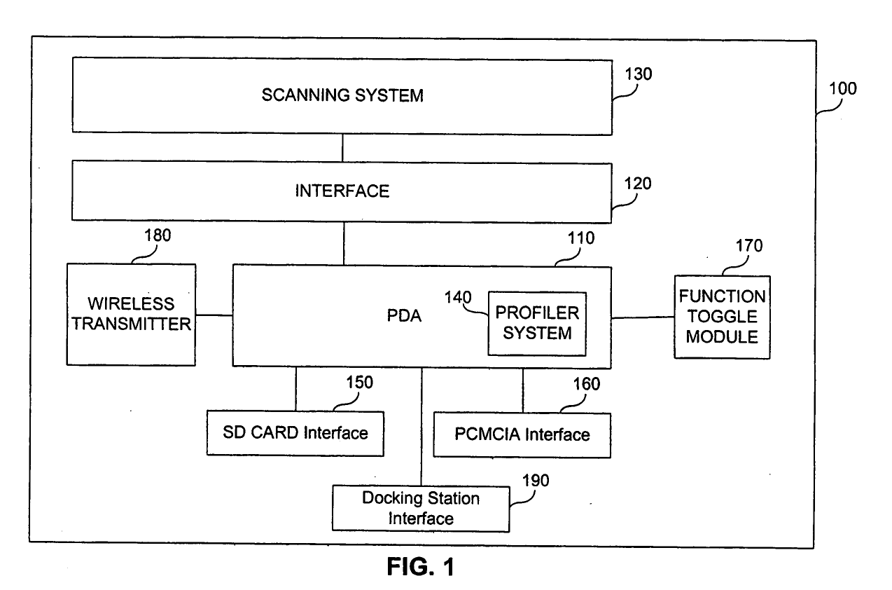

FIG. 1 provides a block diagram of hand-held personal identification analysis device 100, according to an embodiment of the invention. Hand-held personal identification analysis device 100 includes personal data assistant 110, scanning system interface 120, scanning system 130 and profiler system 140. Additionally, hand-held personal identification analysis device 100 includes a variety communication and control interfaces. These interfaces include SD Card Interface 150, PCMCIA interface 160, function toggle module 170, wireless transmitter 180, and docking station interface 190.

Personal data assistant 110 includes a screen for providing a user interface and provides overall system control. Personal data assistant 110 provides computing power for system management and information processing. Personal data assistants (PDAs) that are readily available can be used as personal data assistant 110.

Scanning system interface 120 provides an interface for coupling scanning system 130 to PDA 110. Scanning system interface 120 provides electrical connectivity (e.g., pin connections) and interface software to support the electrical coupling of scanning system 130 and PDA 110. The specific pin arrangements and interface software can vary depending on the type of scanning system and PDA.

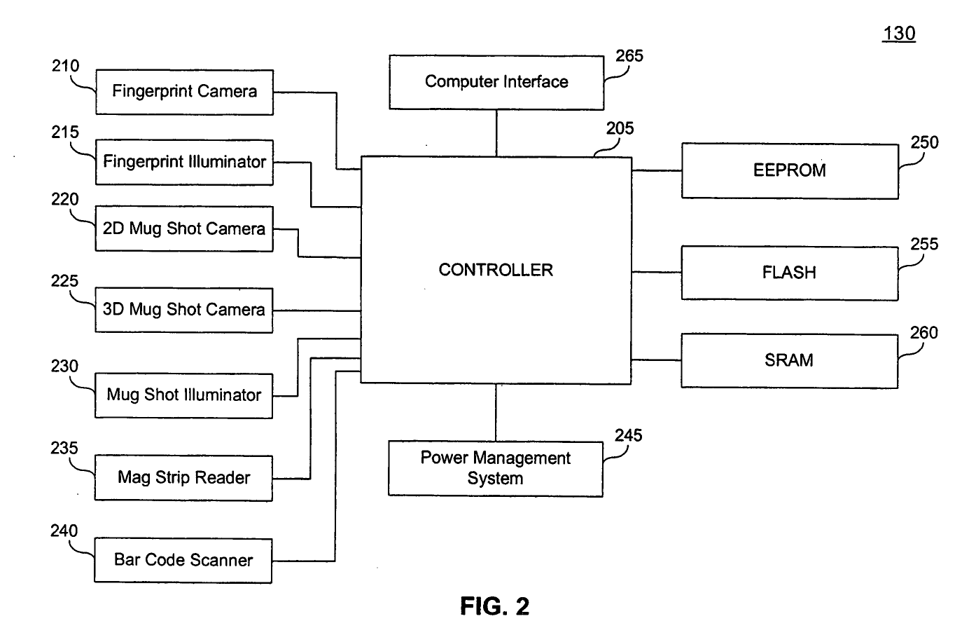

Scanning system 130 gathers biometric and corroborating identity information from individuals. As is discussed with respect to FIG. 2, scanning system 130 can gather a wide variety of biometric information, including, but not limited to fingerprint images, two-dimensional mug shots, and three-dimensional mug shots. Scanning system 130 also can collect corroborating identify information, such as passport numbers, credit card information, license information and the like. Scanning system 130 can process requests for biometric and corroborating information from PDA 110 and transmit gather biometric and corroborating identify information to PDA 110.

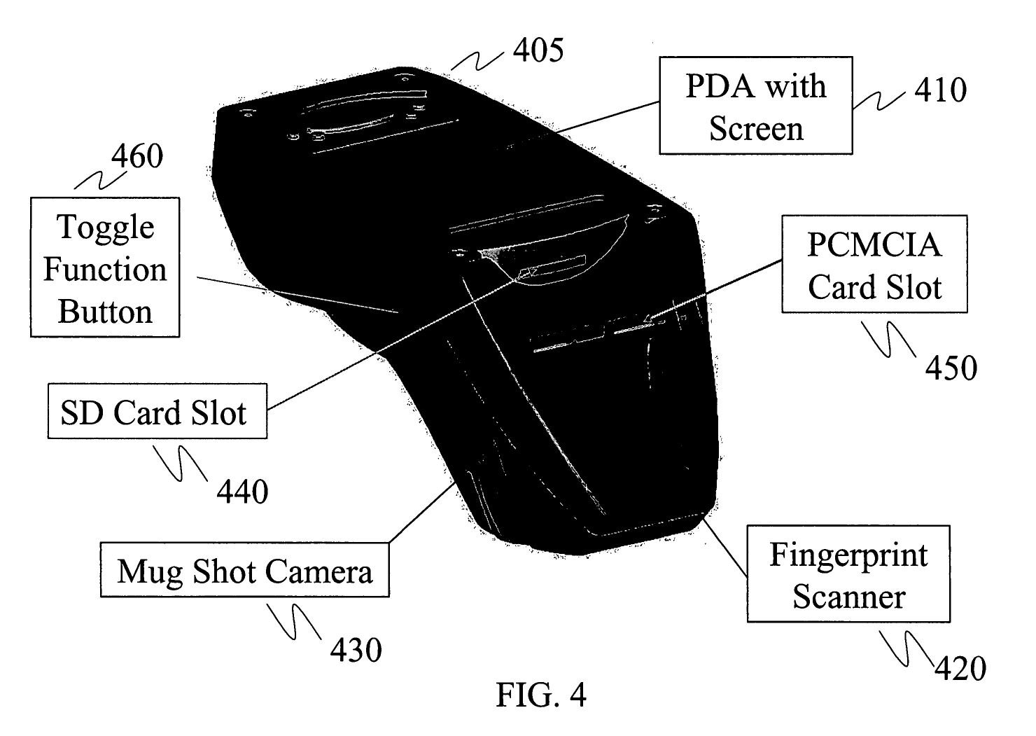

Profiler system 140 develops profiles of individuals based on biometric information gathered from scanning system 140. Additionally, as explained more fully below with respect to FIG. 4, profiler system 140 can combine any combination of capture environment data, individual history data, user authentification data and corroborating identity data with the gathered biometric data to create an individual profile. In an embodiment, profiler system 140 is located within PDA 110. In an alternative embodiment, profiler system 140 can be located within scanning system 130. Profiler system 140 can be implemented using software, hardware or a combination of these as will be known by individuals skilled in the relevant arts based on the teachings herein.

The communications and control interfaces of scanning system 100 provide for flexible use of hand-held personal identification analysis device 100. SD Card interface 150 and PCMCIA interface 160 are coupled to PDA 110, and provide alternative means to provide applications for and control of PDA 110.

Function toggle module 170 supports toggle buttons located on the hand-held personal identification analysis device 100. Function toggle module 170 is coupled to PDA 110, or can be included within PDA 110. The toggle buttons allow a user to control the operation of hand-held personal identification analysis device 100 with a single hand. Function toggle module 170 allows an authorized user or administrator to program the toggle buttons for various uses. For example, the buttons can be programmed to allow a user to toggle through the series of steps needed to take a fingerprint image from an individual.

Wireless transmitter 180 is coupled to PDA 110 and allows hand-held personal identification analysis device 100 to exchange wireless messages. For example, a user of hand-held personal identification analysis device 100 may desire to compare a fingerprint taken from an individual to fingerprints contained in a database at a main processing center. Wireless transmitter 180 can be used to transmit the taken fingerprint image to the main processing center for analysis. Upon the main processing center completing the analysis, wireless transmitter 180 can be used to receive results transmitted by the main processing center.

Docking station interface 190 is coupled to PDA 110 and provides a convenient interface for charging the batteries of hand-held personal identification analysis device 100. Docking station interface 190 can also be used for data synchronization and desktop utilization.

FIG. 2 provides a block diagram of scanning system 130, according to an embodiment of the invention. Scanning system 130 includes controller 205, a set of biometric and corroborating information capture devices, a set of memory devices, computer interface 265 and power management system 245.

Controller 205 manages the overall operation of scanning system 120. In an embodiment controller 205 can be a field programmable gate array (FPGA).

In an embodiment the set of biometric and corroborating information capture devices include fingerprint camera 210, fingerprint illuminator 215, two-dimensional (2D) mug shot camera 220, three-dimensional (3D) mug shot camera 225, mug shot illuminator 230, magnetic strip reader 235 and bar code scanner 240.

The biometric information capture devices include fingerprint camera 210, 2D mug shot camera 220, and 3D mug shot camera 225. In alternative embodiments, hand-held personal identification analysis device 100 can also include other types of biometric capture devices, such as, for example an iris scan device.

Fingerprint camera 210 is coupled to controller 205 and takes print images of fingerprints. Fingerprint illuminator 215 is also coupled to controller 205 and can be used to illuminate a finger for which a print image is being taken. In an embodiment fingerprint illuminator 215 emits short wave length light (e.g., green light) to reduce ambient light interference to enable usage in direct sunlight without a light shield.

2D mug shot camera 220 is coupled to controller 205 and can take two-dimensional mug shot photos of individuals. 2D mug shot camera 220 produces an image that is a single frame that is captured and stored on hand-held personal identification analysis device 100. Mug shot illuminator 230 is also coupled to controller 205 and can be used to illuminate the face of an individual whose mug shot is being taken. In embodiments mug shot illuminator 230 can be an infra-red light source or a flash light source. 3D mug shot camera 225 is also coupled to controller 205. 3D mug shot camera 225 and 2D mug shot camera 220 can be used together to generate a 3D mug shot image of an individual that allows for superior analysis of facial features.

Corroborating information capture devices include magnetic strip reader 235 and bar code scanner 240. These devices can be used to gather corroborating information regarding an individual. For example, magnetic strip reader 235 can be used to read a magnetic strip on a credit card or personal identification card to gather personal information about an individual. Also, bar code scanner 240 can be used to read the bar code information on a United States passport, for example, to gather information about an individual. In one embodiment, hand-held personal identification analysis device 100 can then transmit the passport information to a main processing center. The main processing center could then transmit identifying information, including a stored fingerprint image, to hand-held personal identification analysis device 100 that could be compared to a fingerprint image taken by hand-held personal identification analysis device 100 to verify the identify of an individual.

In an embodiment the set of memory devices include EEPROM 250, FLASH 255 and SRAM 260. The set of memory devices are coupled to controller 205. The set of memory devices can be used to store program information and data collected by the set of biometric and corroborating information capture devices, as will be known by individuals skilled in the relevant arts based on the teachings herein. In an embodiment, scanning system 130 can store calibration and operating parameters of hand-held personal identification analysis device 100 with a memory device.

Computer interface 265 provides an interface to allow scanning system 265 to communicate with a PDA, such as PDA 110. Computer interface 265 is coupled to controller 205. In the embodiment provided, it would also be coupled to scanning system interface 120. Power management system 245 manages the power needed for scanning system 130. Power management system 245 can include a power source control module that determines whether AC or DC power should be used. Additionally, power management system 245 can include a battery, such as a Lithium ion battery, a battery status indicator and a battery charger system. Power management system 245 is coupled to controller 205.

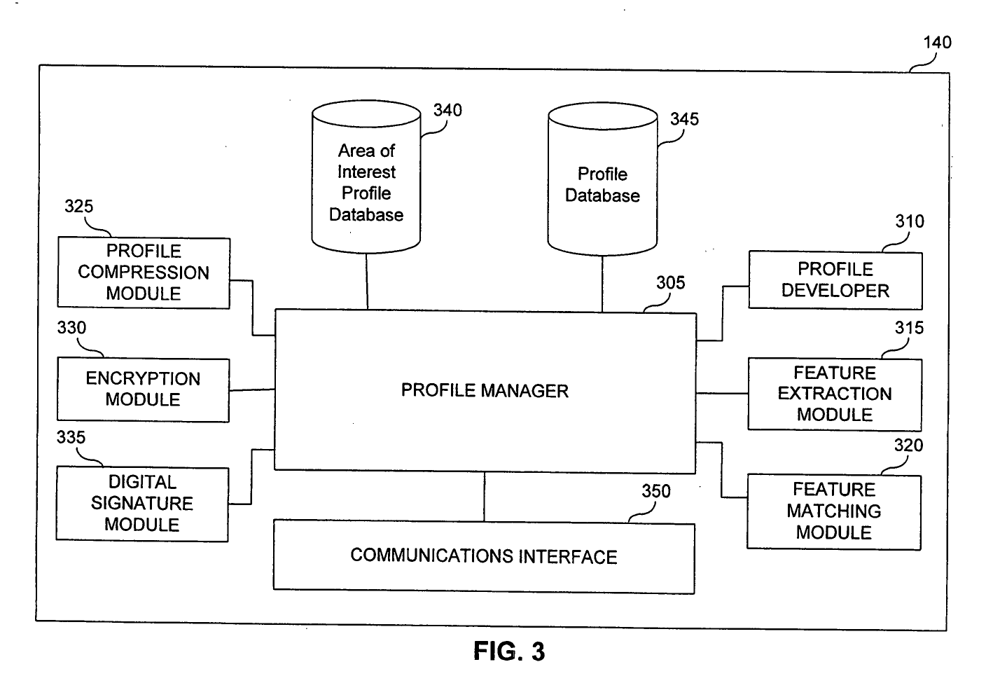

FIG. 3 is a block diagram of profiler system 140, according to an embodiment of the invention. Profiler system 140 includes profile manager 305, profile developer 310, feature extraction module 315, feature matching module 320, profile compression module 325, encryption module 330, digital signature module 335, area of interest profile database 340, profile database 345 and communications interface 350.

Profile manager 305 controls the overall operation of profile system 140. Profile developer 310 develops profiles for individuals being processed. Profile developer 310 combines biometric information that is taken from an individual with supplementary data to create a profile record for further processing, such as internal analysis by hand-held personal identification analysis device 100 or transmittal for external analysis. Supplementary data can include, but is not limited to, capture environment data, individual history data, user authentification data and corroborating field identity data. A profile record developed by profile developer 310 can include, but is not limited to any combination of the types of data. The specific approaches to developing a profile will be application specific.

Capture environment data includes, for example, data, time, and location information at the location where biometric data is being gathered. Individual history data includes general information about individual's movements, activities, police records, etc. The specific data used would be application specific.

For example, in an embodiment, hand-held personal identification analysis device 100 can be used to provide additional airport security through random checks of airport personnel. In this situation, screening may occur at different locations during the course of a day, week, etc. The individual history data can identify where an individual was screened. For example, the individual history data could show that the individual was at baggage check, at a fueling area, or at various terminals. This information could then be used to confirm whether the individual was supposed to be in the particular areas or whether a pattern was developing that suggested the individual was involved in an unauthorized activity.

User authentification data includes data from the user (e.g., a security officer) to authenticate the use of hand-held personal identification analysis device 100. For example, user authentification data can include the name of the user, an identification password for the user, a digital signature of the user, and the like.

Corroborating field identity data can include identity information gathered about an individual other than through the biometric capture devices of hand-held personal identification analysis device 100. For example, information taken from a passport bar code is one type of corroborating field identify data.

Feature extraction module 315 extracts features from biometric images so they can be efficiently stored (into profiles) and analyzed. In an embodiment feature extraction module 315 can also include image scaling and correction capabilities to enhance biometric images. Feature matching module 320 compares features to biometric images taken by hand-held personal identification analysis device 100 with features of stored images or images received over wireless transmitter 180. Both feature extraction module 315 and feature matching module 320 are coupled to profile manager 305.

Profile compression module 325 compresses profiles for efficient storage and transmittal. Encryption module 330 encrypts profiles for storage and transmittal. Digital signature module 335 supports the receipt of digital signatures through a screen on PDA 110 or receipt through another means. All three modules are coupled to profile manager 305.

Profile database 345 stores profiles that are developed by profile developer 310 or received from another source. Profile database 345 allows for a way of storing profiles for later use when a wireless transmitter is unavailable to transmit the profiles, or when it is simply more efficient to provide local storage on hand-held personal identification analysis device 100. Area of interest profile database 340 can be used to store sets of profiles that are of interest for a particular application. For example, an airport security audit firm may only be interested in comparing airport personnel biometric information collected from individuals with profiles of known terrorists. The profiles of known terrorists could be loaded into area of interest profile database 340 to provide for local analysis without the need to send information to a remote processing center.

FIG. 4 is a diagram of hand-held personal identification analysis device 405, according to an embodiment of the invention. FIG. 4 illustrates a perspective drawing showing a hand-held personal identification analysis, such as hand-held personal identification analysis device 100 enclosed within a hand-held enclosure. FIG. 4 illustrates an embodiment showing PDA 410 with a screen, fingerprint scanner 420, mug shot camera 430, SD card slot 440, PCMCIA card slot 450 and toggle function button 460.

In an embodiment, a toggle function button, such as toggle function button 460, is located on each side of hand-held personal identification analysis device 405. Toggle function button 460 is positioned such that a user can hold hand-held personal identification analysis device 405 in one hand, and with the thumb of the same hand toggle the functions of hand-held personal identification analysis device 405 by pressing toggle function button 460. Toggle function buttons can be located on both sides to facilitate right hand and left hand usage.

In an additional embodiment, adjustable hand straps can be used to further simplify use of hand-held personal identification analysis device 405. In another embodiment, hand-held personal identification analysis device 405 includes a stylus storage feature for efficiently storing a stylus used to write on the screen of PDA 405.

Additionally, to facilitate ease of use, a fingerprint capture surface of fingerprint scanner 420 is positioned at an oblique angle to the screen of PDA 410. Futhermore, a fingerprint camera of fingerprint scanner 420 is positioned at an oblique angle to the screen of PDA 410. Likewise, mug shot camera 430 is positioned at an oblique angle to the screen of the PDA to facilitate usage of the screen to monitor the image capture process.

Fingerprint scanner 420 can also include a number of features that improve its robustness. In an embodiment, fingerprint scanner 420 can include a silicon pad to provide for enhanced fingerprint images. Additionally, in an embodiment, hand-held personal identification analysis device 405 can support dark field illumination, bright field illumination or both. In another embodiment fingerprint scanner 420 can support platen heating and cooling. In general hand-held personal identification analysis device 405 supports rugged operation in a wide variety of environmental conditions.

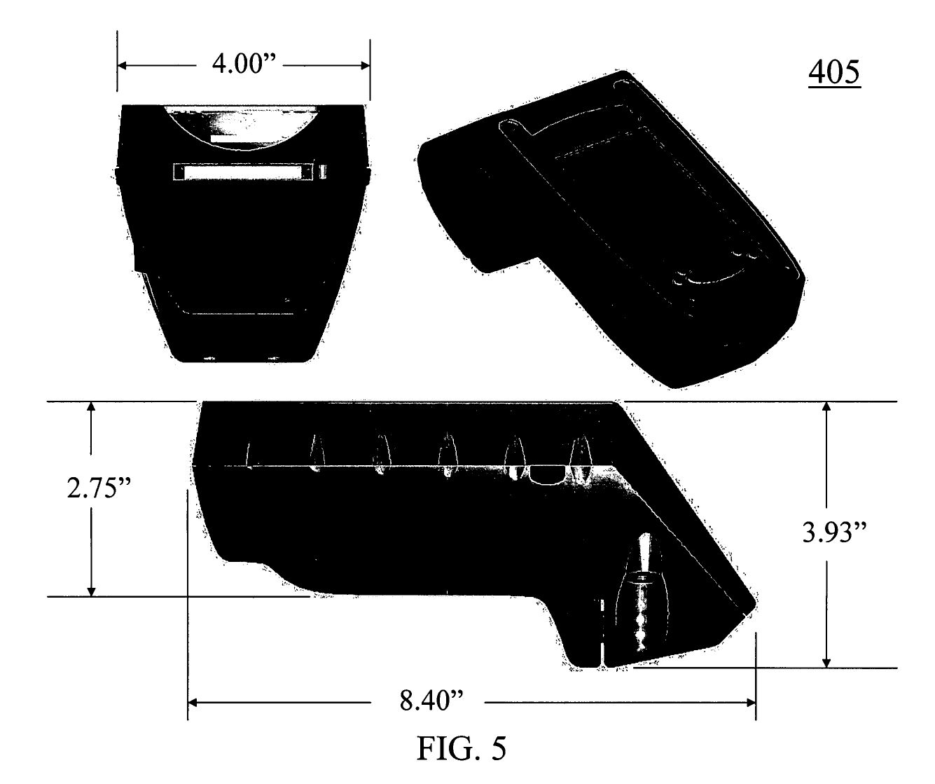

FIG. 5 is a diagram of a collection of perspective views of a hand-held personal identification analysis device, according to an embodiment of the invention. FIG. 5 provides a front, side and angled perspective view of an embodiment of hand-held personal identification analysis device 405. In one embodiment, hand-held personal identification analysis device 405 can have a length of approximately 8.4 inches, a front height, where fingerprint scanner 420 and mug shot camera 430 are located of about 4 inches and a rear height, where a user would grasp hand-held personal identification analysis device 405 of about 2.75 inches. These dimensions are example dimensions, and not intended to limit the scope of the invention.

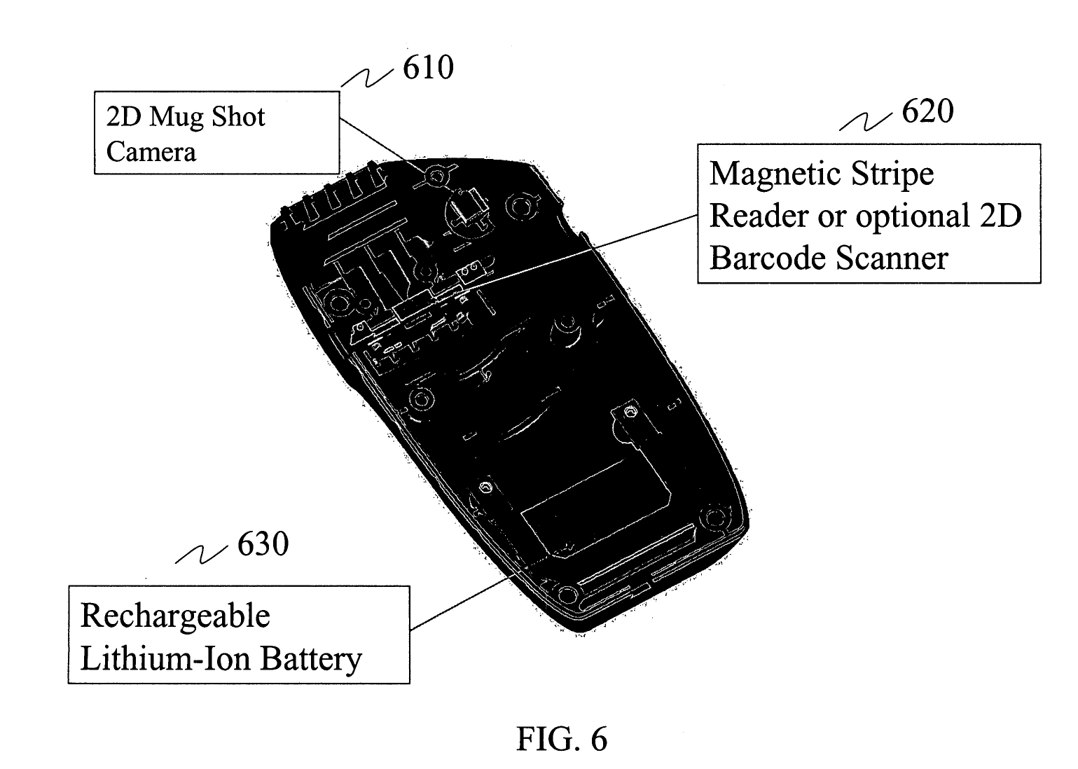

FIG. 6 is a diagram of a bottom portion of an enclosure for a hand-held personal identification analysis device 405, according to an embodiment of the invention. FIG. 6 illustrates the internal location of 2D mug shot camera 610, magnetic strip reader 620 and lithium ion battery 630.

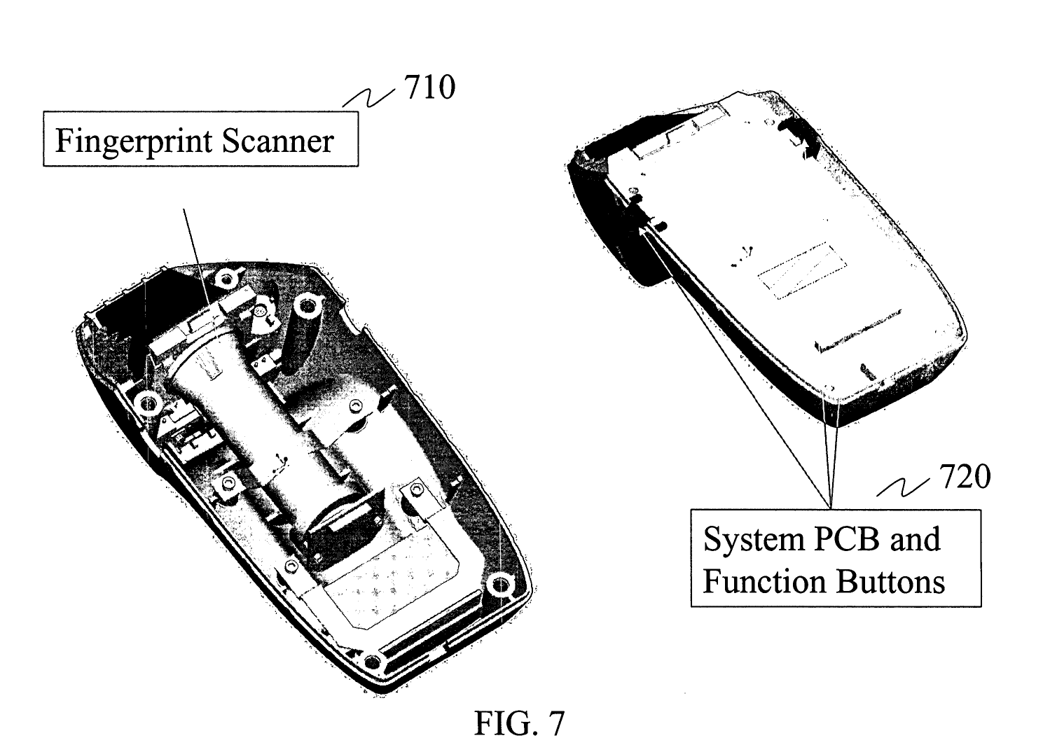

FIG. 7 is a diagram of a bottom and top portion of an enclosure for hand-held personal identification analysis device 405, according to an embodiment of the invention. FIG. 7 illustrates a bottom and top portion of an enclosure highlighting the internal location of fingerprint scanner 710 and function toggle buttons 720.

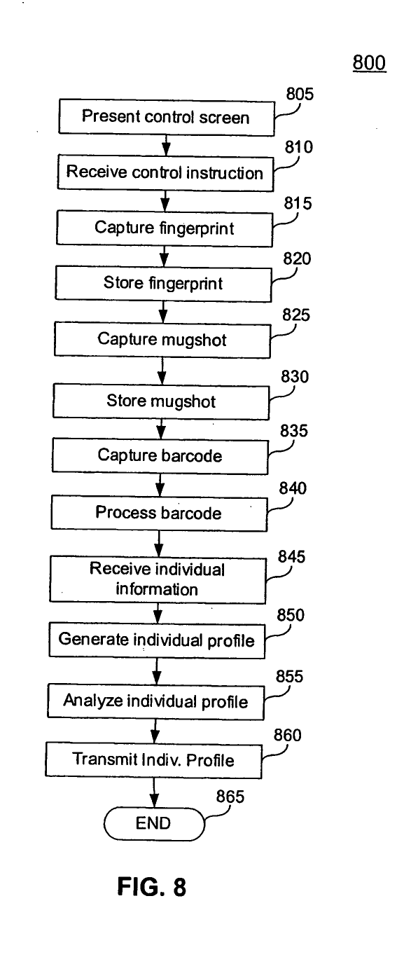

FIG. 8 is a flowchart of a method 800 for processing personal identity information of an individual using a hand-held personal identification analysis device, according to an embodiment of the invention.

Method 800 begins in step 805. In step 805 a control screen is presented to a user. For example, a control screen could be presented on a user interface on a screen of PDA 110. In step 810, control instructions are received. For example, hand-held personal identification analysis device 100 could receive control instructions from a user entering a choice presented on the user interface. Or in another case, a user could use a function toggle button, such as function toggle button 460 to provide an instruction to hand-held personal identification analysis device 405.

In step 815, a fingerprint image is captured by a hand-held personal identification analysis device, such as hand-held personal identification analysis device 100. In step 820, the captured fingerprint image is stored. For example, in an embodiment the fingerprint can be stored in FLASH memory 255 or in temporary memory within profiler system 140.

In step 825 a mug shot image is captured. For example, mug shot camera 430 can be used to capture an image of an individual. In step 830, the mug shot image is stored. For example, in an embodiment the mug shot can be stored in FLASH memory 255 or in temporary memory with profiler system 140.

In step 835 bar code information is captured. In step 840 the barcode information can be stored. In an alternative embodiment, for example, a magnetic strip on a credit card can be read to gather information.

In step 845 individual information is received or gathered. This information can include supplementary information, as described above, or information based on the bar code information.

In step 850 an individual profile is generated. For example, profile developer 310 can combine the captured biometric data with supplementary data. In step 855 the profile is analyzed. For example, feature matching module 320 can be used to compare the profile to profiles stored in area of interest profile database 340. Alternatively, a profile can be requested over wireless transmitter 180. The received profile can then be analyzed. In step 860, in an embodiment the profile is transmitted to a main processing center for further processing. In many cases, step 860 may not be needed. That is, the profile can be stored in a profile database, such as profile database 345 for later analysis or analysis done in step 855 will be sufficient. In step 865, method 800 ends.

Conclusion

Exemplary embodiments of the present invention have been presented.

The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. A hand-held personal identification analysis device, comprising:
a scanning system for gathering biometric information from individuals;
a profiler system for developing profiles of individuals based on biometric information gathered from said scanning system;
a personal data assistant (PDA) having a screen for providing a user interface and overall system control; and
a scanning system interface for coupling said scanning system to said PDA.

2. The personal identification analysis device of claim 1, further comprising a wireless transmitter coupled to said PDA.

3. The personal identification analysis device of claim 1, wherein said personal identification analysis device can be operated with a single hand.

4. The personal identification analysis device of claim 1, further comprising a hand-held enclosure for housing said scanning system, said profiler system, said computer module and said scanning system interface.

5. The personal identification analysis device of claim 4, further comprising:
a function toggle button on each side of said hand-held enclosure, wherein each of said function toggle buttons can be operated by a user's thumb while holding said hand-held enclosure; and
a function toggle module for interfacing said function toggle buttons with said PDA.

6. The personal identification analysis device of claim 5, wherein said function toggle button is programmable.

7. The personal identification analysis device of claim 1, further comprising a docking station interface.

8. The personal identification analysis device of claim 1, wherein said scanning system comprises:
a controller for managing said scanning system;
a fingerprint camera coupled to said controller for taking print images of fingerprints; and
a fingerprint illuminator coupled to said controller for illuminating a finger for said fingerprint camera.

9. The personal identification analysis device of claim 8, wherein said fingerprint camera is arranged at an oblique angle relative to the screen on said PDA.

10. The personal identification analysis device of claim 8, further comprising a fingerprint capture surface, wherein said fingerprint capture surface is arranged at an oblique angle to the screen on said PDA.

11. The personal identification analysis device of claim 8, wherein said fingerprint illuminator emits short wave length light to reduce ambient light interference to enable usage in direct sunlight without a light shield over the fingerprint capture device.

12. The personal identification analysis device of claim 1, wherein said scanning system comprises:
a controller for managing said scanning system;
a two-dimensional mug shot camera coupled to said controller for taking two dimensional mug shot photos;
a mug shot illuminator coupled to said controller for illuminating an individual for said two-dimensional mug shot camera.

13. The personal identification analysis device of claim 12, wherein said scanning system comprises a three-dimensional mug shot camera coupled to said controller for taking three dimensional mug shot photos.

14. The personal identification analysis device of claim 1, wherein said scanning system comprises:
a controller for managing said scanning system;
a fingerprint camera coupled to said controller for taking print images of fingerprints; and
a fingerprint illuminator coupled to said controller for illuminating a finger for said fingerprint camera.
a two-dimensional mug shot camera coupled to said controller for taking two dimensional mug shot photos;
a three-dimensional mug shot camera coupled to said controller for taking three dimensional mug shot photos;
a mug shot illuminator coupled to said controller for illuminating an individual for said two-dimensional and three-dimensional mug shot camera.

15. The personal identification analysis device of claim 14, further comprising a magnetic strip reader coupled to said controller.

16. The personal identification analysis device of claim 14, further comprising a bar code scanner coupled to said controller.

17. The personal identification analysis device of claim 14, wherein said mug shot illuminator is an infra-red light source.

18. The personal identification analysis device of claim 14, wherein said mug shot illuminator is a flash light source.

19. The personal identification analysis device of claim 1, wherein said profiler system comprises a profile developer that creates an individual profile by combining a stored biometric image with supplementary data.

20. The personal identification analysis device of claim 19, wherein said supplementary data includes capture environment data.

21. The personal identification analysis device of claim 19, wherein said supplementary data includes individual history data.

22. The personal identification analysis device of claim 19, wherein said supplementary data includes user authentification data.

23. The personal identification analysis device of claim 19, wherein said supplementary data includes corroborating field identity data.

24. The personal identification analysis device of claim 1, wherein said profiler system comprises a profile compression system to reduce profile size and transmission times.

25. The personal identification analysis device of claim 1, wherein said profiler system comprises a biometric feature extraction module.

26. The personal identification analysis device of claim 1, wherein said profiler system comprises a biometric feature matching module.

27. The personal identification analysis device of claim 1, wherein said profiler system comprises an area of interest individual profile database.

28. The personal identification analysis device of claim 1, wherein said profiler system comprises an encryption module for ensuring that individual profiles are not corrupted.

29. The personal identification analysis device of claim 1, wherein said profiler system comprises a digital signature module for authenticating use of said personal identification analysis device.

30. The personal identification analysis device of claim 2, wherein said wireless transmitter transmits profiles of individuals.

31. A method to analyze personal identity information of an individual, comprising the steps of:
(a) presenting a user interface control screen on a user interface of a hand-held personal identification analysis device;
(b) receiving control instruction;
(c) capturing biometric information from the individual using a scanning system of a hand-held personal identification analysis device;
(d) developing a personal identification profile; and
(e) analyzing the personal identification profile.

32. The method of claim 31, wherein step (c) biometric information includes a fingerprint image.

33. The method of claim 31, wherein step (c) biometric information includes a mug shot image.

34. The method of claim 31, wherein step (c) biometric information includes an iris image.

35. The method of claim 31, wherein step (d) developing a personal identification profile comprises the steps of:
(i) receiving capture environment data;
(ii) combining capture environment data and biometric information to create the personal identification profile.

36. The method of claim 31, wherein step (d) developing a personal identification profile comprises the steps of:
(i) receiving individual history data;
(ii) combining individual history data and biometric information to create the personal identification profile.

37. The method of claim 31, wherein step (d) developing a personal identification profile comprises the steps of:
(i) receiving user authentification data;
(ii) combining user authentification data and biometric information to create the personal identification profile.

38. The method of claim 31, wherein step (d) developing a personal identification profile comprises the steps of:
(i) receiving corroborating field identity data;
(ii) combining corroborating field identity data and biometric information to create the personal identification profile.

39. The method of claim 31, wherein step (d) developing a personal identification profile comprises the steps of:
(i) receiving capture environment data;
(ii) receiving individual history data;
(iii) receiving user authentification data;
(iv) receiving corroborating field identity data;
(v) combining corroborating capture environment data, individual history data, user authentification data, corroborating field identity data and biometric information to create the personal identification profile.

40. A method to process personal identity information of an individual, comprising the steps of:
(a) presenting a user interface control screen on a user interface of a hand-held personal identification analysis device;
(b) receiving control instruction;
(c) capturing biometric information from the individual using a scanning system of a hand-held personal identification analysis device;
(d) developing a personal identification profile; and
(e) transmitting the personal identification profile.

41. The method of claim 40, wherein step (e) developing a personal identification profile comprises affixing a digital signature of a user to the personal identification profile.

42. The method of claim 40, wherein step (e) developing a personal identification profile comprises encrypting the personal identification profile.

43. The method of claim 40, wherein step (e) developing a personal identification profile comprises compressing the personal identification profile.
